(19) United States
(12) Patent Application Publication
(10) Pub. No.: US 2004/0164824 A1
(43) Pub. Date: Aug. 26, 2004

(54) Hyperspace energy generator

(76) Inventor: John Quincy St. Clair, San Juan, PR (US)

Correspondence Address: John St. Clair, Hyperspace Research Institute, 52 Kings Court, 4A, San Juan, PR, 00911, US

(21) Appl. No.: 10/372,556

(22) Filed: Feb. 21, 2003

(51) Int. Cl. H01P 3/06

(52) U.S. Cl. 333/243

(57) ABSTRACT

This invention is a braided gold wire coaxial cable of micron size which generates hyperspace energy by coupling to the tetrahedral geometry of subspace, dimension and the Planck mass.

### BRIEF SUMMARY OF THE INVENTION

This invention is a braided gold wire coaxial cable of micron size which generates hyperspace energy.

### BACKGROUND OF THE INVENTION

Electrical experiments with micron-sized braided gold wire coaxial cable show that it is capable of generating substantial amounts of hyperspace energy. Referring to the electron microscope photograph shown in FIG. 1, the white mist emanating from the cable is low-density hyperspace energy that is flowing in from a co-dimension of our universe. The dimensions of the cable are of such a particular size as to couple the cable to the tetrahedral geometry of subspace, the dimension of space, the Planck mass and the linear inductance of the universe.

According to physicist Dr. Edward Witten of Princeton University, space has twenty-four dimensions, of which ten dimensions are non-redundant. Imagine taking a path around the Pythagorean triangle, as known as the planar tetrahedron, with sides equal to {\sqrt{1}, \sqrt{2}, \sqrt{3}} as shown in FIG. 2. There are three squares denoted the one-square (A), the two-square (B) and the three-square (C). Each square has four sides. The edge of each square can be traversed in two directions. Thus the total number of dimensions is

dimₜₒₜₐₗ=2·(4+4+4)=24

Referring to FIG. 3, there is a path starting at the corner of the triangle, along the one-square (1), around the two-square (2,3,4,5), back along the one-square (6), around the three-square (7,8,9,10) and back to the corner of the triangle. The numbering of the edges shows that there are ten edges. Because the path is traversed in only one direction, the number of reduced dimensions is

dim_{reduced}=1·(10)=10

Referring to FIG. 4, the planar tetrahedron (B) forms one edge of the three-dimensional tetrahedron (A). Rotating the planar tetrahedron ±120° produces the other two edges. The tetrahedron has four faces which are equilateral triangles. The ten dimensional path starts and ends at (C), the corner of the tetrahedron known as the zero point.

Referring to FIG. 5, the projection of the 3D tetrahedron (A) onto a plane is called the tetrahedron diagram (B) which is the main diagram of the new geometrical physics known as Δphysics. All the constants of physics can be derived geometrically from the tetrahedron diagram and its associated planar tetrahedron. An example of this is shown in FIG. 6 where the edges are given specific constants related to tetrahedral geometry, dimension, curvature, and the mass and wavelength of the elementary particles such as the electron and proton. The ten dimensional path includes the following constants

a. electron wavelength

b. proton wavelength

c. 47π The solid angle of the sphere. The tetrahedron is circumscribed by a sphere.

d. ln(2π) The natural log of the curvature. The subspace geometry is a logarithmic manifold. The tetrahedron diagram plots the logarithm of mass versus the logarithm of wavelength.

e. 0.599547652 A constant related to fractal dimension and the speed of light factor 2.99792458.

f. \sqrt{2} The edge of the two-square.

g. \sqrt{10}/10 The square root of ten dimensions per 10 dimensions.

h. ln(ΩΛc)−1 The natural log of the momentum of space less one.

i.

$$\frac{2 π}{10}$$

The curvature of space per 10 dimensions.

j. \sqrt{2} The edge of the two-square.

The length of each edge is multiplied by the constant assigned to that edge. The ten edges have the order of {\sqrt{1}, \sqrt{2}, \sqrt{2}, \sqrt{2}, \sqrt{1}, \sqrt{3}, \sqrt{3}, \sqrt{3}, \sqrt{3}}. What subspace geometry does is to multiply the edge length, such as \sqrt{1}, times the square root of two \sqrt{2}. Then it takes the square root of that number and multiplies it by the next edge, which is \sqrt{2}, times the curvature per 10 dimensions

$$\frac{2 π}{10} .$$

It then takes the square root of that number and so on. In equation form, this looks like the following calculation

$$\sqrt{3 a \sqrt{3 b \sqrt{3 c \sqrt{3 d \sqrt{1 e \sqrt{2 f \sqrt{2 g \sqrt{2 h \sqrt{2 i \sqrt{1 j}}}}}}}}}} = 80.1104395$$

where the letters correspond to those in the list of constants. The square root sum total is equal to the Planck scale Λwhich is the bottom dimensional limit of the universe. The sum of the ten constants per a speed of light circumference is equal to unity

$$\frac{{\sum }_{n = 10}^{} {s}_{n}}{2 π ln ( c )} = 1.000000000$$

where the log of the speed of light is

ln(c)=ln(299792458)=19.51860099

and multiplying by 2π is the circumference of a circle with a radius equal to the speed of light.

Referring to FIG. 7, the tetrahedron diagram plots the natural logarithm of mass on the vertical axis (C) versus the natural logarithm of wavelength on the horizontal axis (A). The reason for this is that the mass of the electron times its wavelength is equal to the mass of the proton times its wavelength which in turn is equal to Planck's constant h divided by the speed of light, known as the base constant (B). If two numbers multiply, they sum in logarithms. In subspace geometry, the sum of the logarithm of the mass of the electron plus the logarithm of the wavelength is equal to the logarithm of the base constant which has a value of −95.91546344.

$$ln ( {m}_{electron} ) + ln ( {λ}_{electron} ) = ln ( \frac{h}{c} ) = - 95.91546344$$

What this means is that the mass and wavelength slide on a 45° base line (D) which has end points on the vertical and horizontal axes equal to the base constant.

Referring to FIG. 8, a line (af) drawn from the origin at the tetrahedral angle of 19.47122063, equal to the asin(⅓), creates a tetrahedron (F) along path (afg). This tetrahedron is circumscribed by a sphere (G) with sphere diameter (K).

The Planck scale path calculation showed that the electron mass and the proton wavelength were the last two edges. The electron mass has a value of

ln(mₑ)=−69.17083217

and the electron wavelength has a value of

ln(λ_{E})=−26.74463127

Referring to FIG. 9, the electron wavelength (A) is plotted as a vertical line on the tetrahedron diagram. The wavelength reflects off the circumscribing sphere (G), and returns as the electron mass (B). So the diagram incorporates the concepts of both classical physics (point mass particles) and quantum mechanics (wave particles).

The proton wavelength has a value of

ln(λₚ)=−34.26005901

The proton wavelength (C) is plotted as a horizontal line in order to get the intersection (b) with the electron mass.

Referring to FIG. 10, a circle (D) with a radius equal to the Planck scale is drawn centered (b) on the intersection of the electron mass with the proton wavelength, which are the last two edges of the Planck scale calculation. A line (ac) from the origin to the intersection of the base constant with the rotated tetrahedron creates the vertical tetrahedron (acd). As can be seen, the Planck scale is tangent to the tetrahedron on side (cd). This tetrahedron is the projection of the 3D tetrahedron shown before in FIG. 5. What this means is that the tetrahedral geometry of subspace determines the bottom limit of our universe. And this bottom limit, called the Planck scale, contains within itself the mass and wavelength of the elementary particles, curvature, dimension and planar tetrahedral geometry. Tetrahedron diagram tet0565 shows that the electron and proton are one and the same particle because the electron path rotates counterclockwise around the curvature and then returns clockwise as the proton path. This path occurs moving through space and hyperspace. Because the single particle enters our universe from hyperspace at two different positions, we see it as two distinct particles. Thus the tetrahedron diagram shows that hyperspace exists.

The speed of light is equal to the inverse of the square root of the permeability μ of space times the permittivity ε of space

$$c = \sqrt{\frac{1}{μ ϵ}}$$

The permeability is linear inductance or inductance per length which you would find in a solenoid for example. The permittivity is linear capacitance or capacitance per length which you find in a capacitor. In an electrical circuit, the inductance and capacitance form a resonant circuit. The resonance frequency can be changed by changing the inductor or capacitor. In a similar manner, the speed of light is not constant, but can be lowered by increasing the permittivity. Hyperspace energy has a high permittivity and therefore a low speed of light. This low speed of light gives hyperspace energy a luminescent quality which is seen as a white mist (FIG. 1).

From Einstein's General Theory of Relativity, the stress pressure T on spacetime is proportion to the square of the ratio of the electric field E to the speed of light c.

$$T = {( \frac{E}{c} )}^{2}$$

Thus substantially lowering the speed of light creates an enormous spacetime pressure which can be used to generate the lift force on electromagnetic field propulsion vehicles. Furthermore, the electric field is subject to the Lorentz transformation

$$E = \frac{{E}_{0}}{\sqrt{1 - \frac{{v}^{2}}{{c}^{2}}}}$$

The electric field E₀ moving in a frame velocity of v, can quickly attain relativistic proportions because the speed of light could be 1 meter per second, rather than the enormous value in our universe of 299792458 meters per second. Thus one would like to permeate the hull of the electromagnetic field propulsion vehicle with this hyperspace energy in order to increase the electric field and hence the spacetime curvature around the hull which produces the enormous lift force on the vehicle. The method of bringing in this hyperspace energy is to use braided gold wire coaxial cable which is coupled to the geometry of subspace. The subspace geometry is contained in the Δphysics tetrahedron diagram.

Just as space has a linear inductance and linear capacitance, it also has a linear mass Ω or mass per meter. Physicist Dr. John A. Wheeler of Princeton likes to invert this and call it “mom” for meter of mass. The Planck mass is equal to the Planck scale Λtimes the linear mass Ω

ln(m_{Plank})=ln(ΩΛ)=−17.64290101

Planck's constant h is equal to 2π times the Planck scale squared times the linear mass Ω times the speed of light c.

h=2πΛ² Ωc=2πΛ(ΩΛ)c

which shows that Planck's constant is actually the circumference of a circle of radius Planck scale times the Planck mass times the speed of light. The base constant is therefore

$$base = \frac{h}{c} = \frac{2 π Λ ( Ω Λ ) c}{c} = ( 2 π Λ ) ( Ω Λ ) = - 95.91546344$$

which is an area, known as the Planck box, bounded by the Planck wavelength (2πΛ) and the Planck mass. Everything outside the Planck box is hyperspace. Everything inside the Planck box is our universe. Thus the boundary between space and hyperspace is the Planck wavelength and the Planck mass. In logarithms, notice that the Planck mass and Planck wavelength, just like the electron and proton, sum to the base constant.

Referring to FIG. 11, the Planck mass (A) and the Planck wavelength (B) are plotted on the diagram and reflected off the sphere. The Planck wavelength intersects the tetrahedron at (b) which is the boundary between space and hyperspace known as the centerline of the diagram. The centerline has a value equal to the base times the square root of 4/3.

$$centerline = \sqrt{\frac{4}{3}} base = - 110.7536373$$

Referring to FIG. 12, the centerline (C) is drawn on the diagram and the tetrahedron (E) is mirrored (F) across the centerline to indicate the co-dimensions of hyperspace.

Referring to FIG. 13, a circle (H), centered at the base at the base (c), tangent to the centerline (C), has a radius equal to base times the square root of 4/3 less one

$$R = ( \sqrt{\frac{4}{3}} - 1 ) base = 14.83817383$$

This is the length that has to traversed in order to cross over the centerline from the base constant of our universe to the co-dimension of hyperspace. Furthermore, the Planck mass, which is the other boundary, has to be crossed in order to get to either axis as seen by the length between the vertical axis and line (A). It can be looked at also as the length needed to go from the Planck wavelength (B) to the tangent point of circle (H) in order to reach the center of the mirror tetrahedrons.

### SUMMARY OF THE INVENTION

This invention is a braided gold wire coaxial cable of micron size that is coupled to the subspace geometry of the universe for the purpose of bringing in low-density hyperspace energy into our universe from the co-dimensions of hyperspace. The dimensions of the coaxial cable are of such particular size as to enable it to couple to the ten dimensions of space, the 3:1 geometrical ratio of the tetrahedron, the coaxial wave function based on the logarithm of the ratio of the outer radius to the inner radius of the cable, the length between the base constant of our universe and the centerline between mirror tetrahedrons, and the geometrical relationship between the Planck mass and the linear inductance of the cable.

Referring to FIG. 14, the coaxial guide has an outer braided conductor (A) and an inner braided conductor (B) in which the outer and inner conductors are at radii a and b respectively. The linear inductance L of the cable is equal to the natural logarithm of the ratio of the radii times the permeability μ of space divided by the curvature 2π

$$L = ln ( \frac{a}{b} ) \frac{μ}{2 π}$$

It can be shown that the ratio of the area-to-volume ratio of the tetrahedron to the area-to-volume ratio of its circumscribing sphere is 3:1. It is also the ratio of the area of the three-square to the area of the one-square on the planar tetrahedron. It is also the tetrahedral angle asin(⅓) equal to 19.47122063°. It is also a maximum work condition between the velocity ratio of a fluid stream and a moving vane such as in turbomachinery. So the first constraint on the radii is

$$exp ( ln ( \frac{a}{b} ) + 1 ) ≡ 3$$

The second constraint is that the radius c of the circle, equal to the difference between the base constant and the centerline, is related to ten dimensions. The value of the radius projected into our universe is

$$c = ( \sqrt{\frac{4}{3}} - 1 ) base = .3596358547 \cdot microns$$

and the dimensional constraint is

$${[ ln ( c ) + ln ( \frac{1}{a} ) ]}^{2} = 10$$

The coaxial wave function constraint is

$$\frac{{ln ( a )}^{2}}{2 πln ( \frac{a}{b} )} ≡ {ln ( c )}^{2}$$

The linear inductance of the coaxial cable has to be such that it gets geometrically across the Planck mass which is the second boundary of our Planck box

$$exp ( ln ( ΩΛ ) - ln ( \frac{ln ( \frac{a}{b} )}{2 π} μ ) + 1 ) ≡ 3$$

With these four subspace constraints, the outer radius a and inner radius b of the cable are

a=8.342461828 microns

b=7.559058141 microns

so the cable has an outside diameter of roughly 16 to 17 microns.

### STATEMENT REGARDING FEDERALLY SPONSORED RESEARCH OR DEVELOPMENT

Not Applicable.

### A BRIEF DESCRIPTION OF THE DRAWINGS

FIG. 1. Electron microscope photograph of the coaxial cable and hyperspace mist.

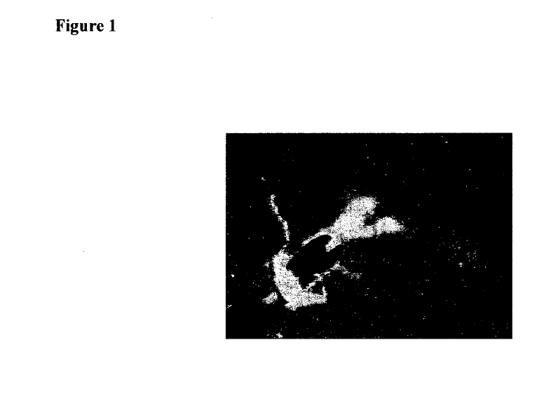

FIG. 2. The planar tetrahedron.

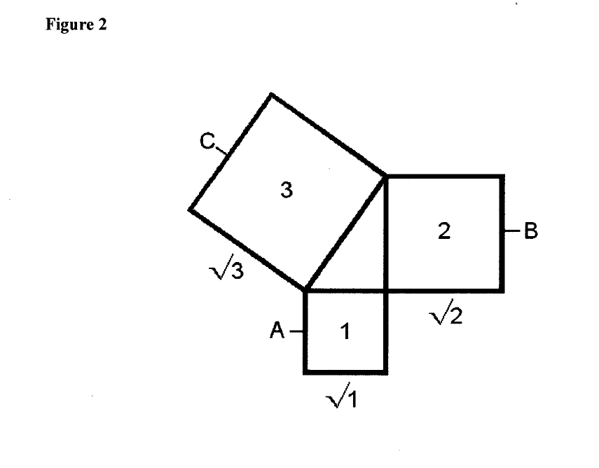

FIG. 3. The ten dimensional path around the planar tetrahedron.

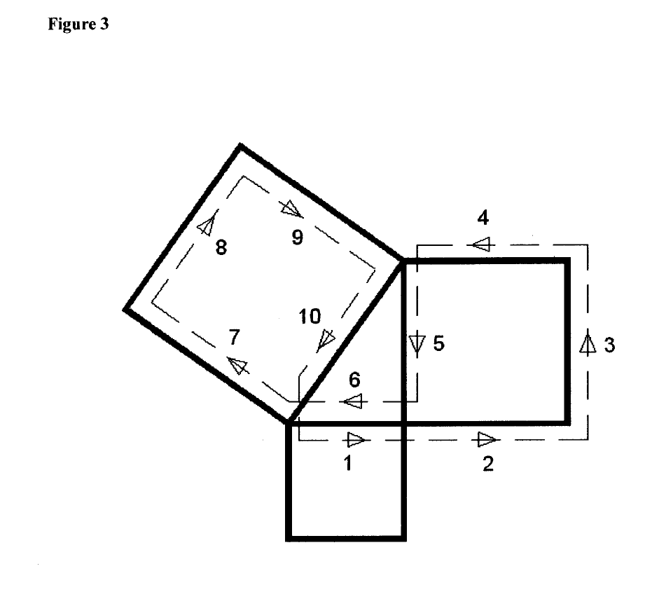

FIG. 4. The relationship between the planar tetrahedron and the 3D tetrahedron.

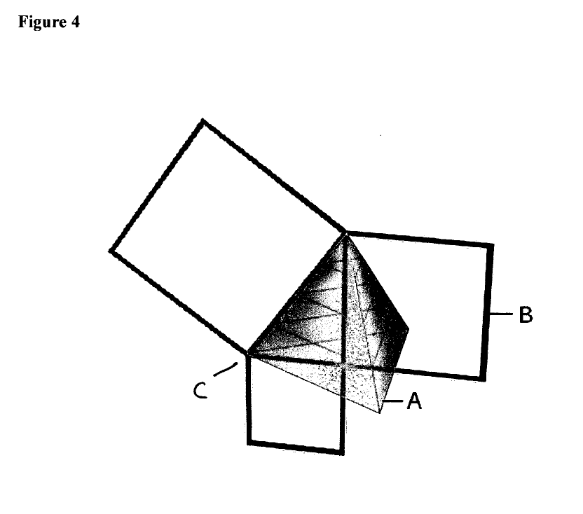

FIG. 5. Projection of the 3D tetrahedron onto a plane to create the tetrahedron diagram.

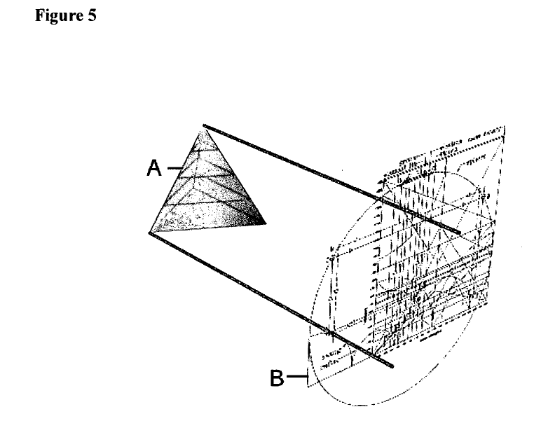

FIG. 6. Dimension, geometry, curvature and elementary particles that make up the ten dimensional Planck scale path.

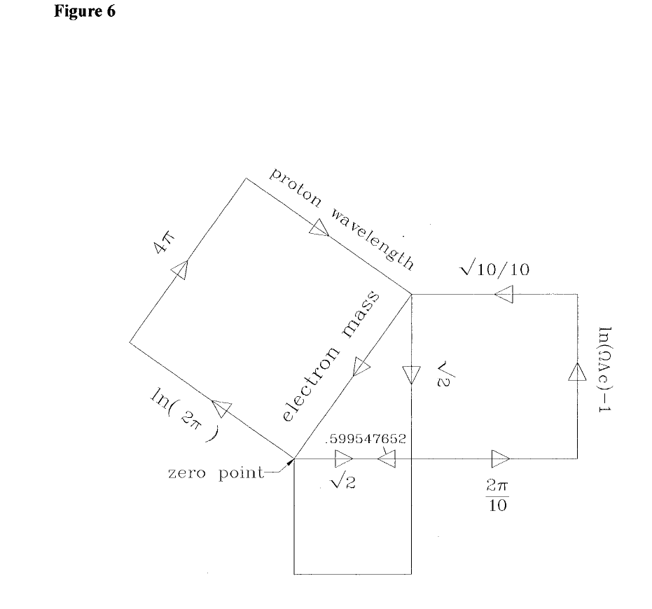

FIG. 7. Tetrahedron diagram showing base constant.

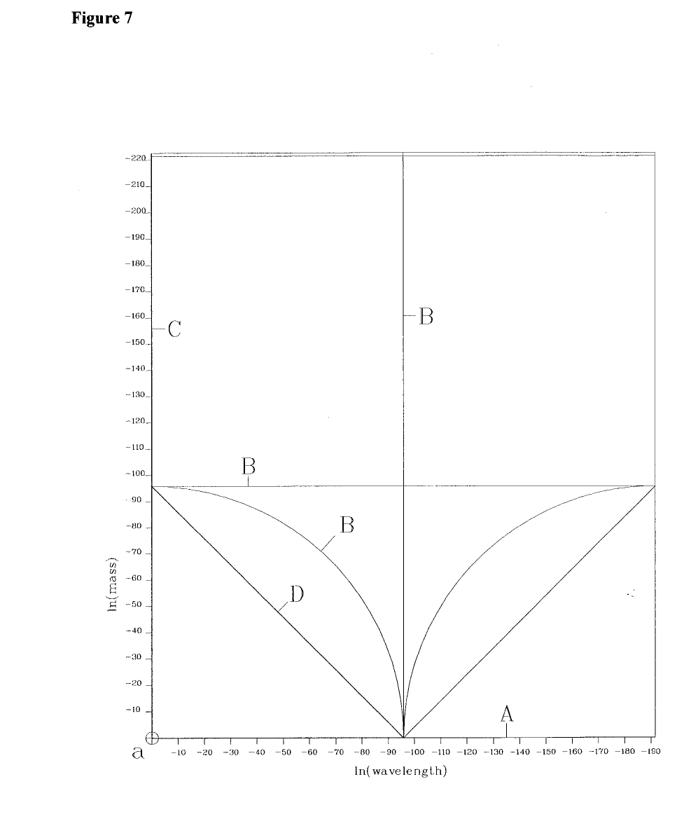

FIG. 8. Tetrahedron diagram showing rotated tetrahedron and circumscribing sphere with electron mass and wavelength reflecting off sphere.

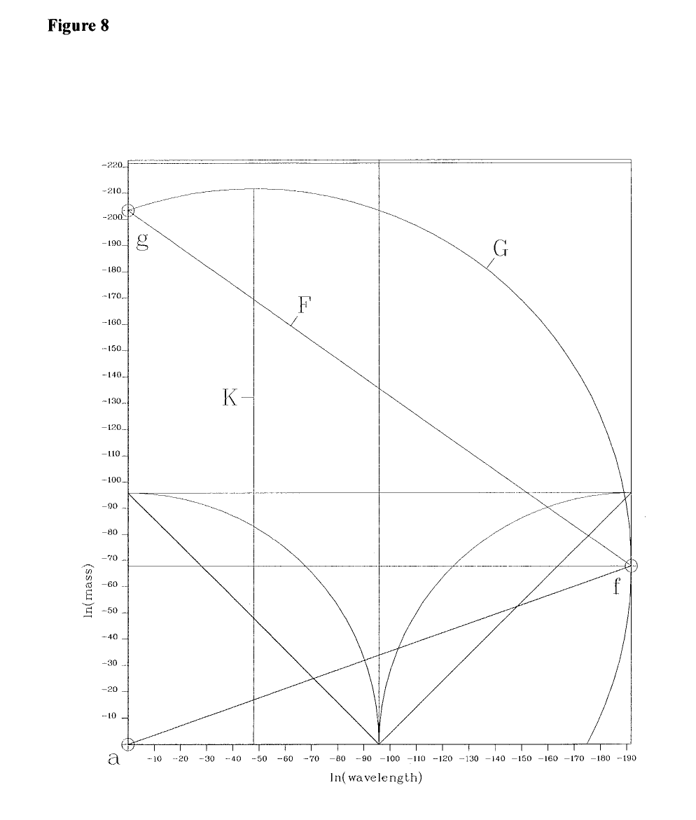

FIG. 9. Tetrahedron diagram showing intersection of electron mass with proton wavelength which are components of the Planck scale path.

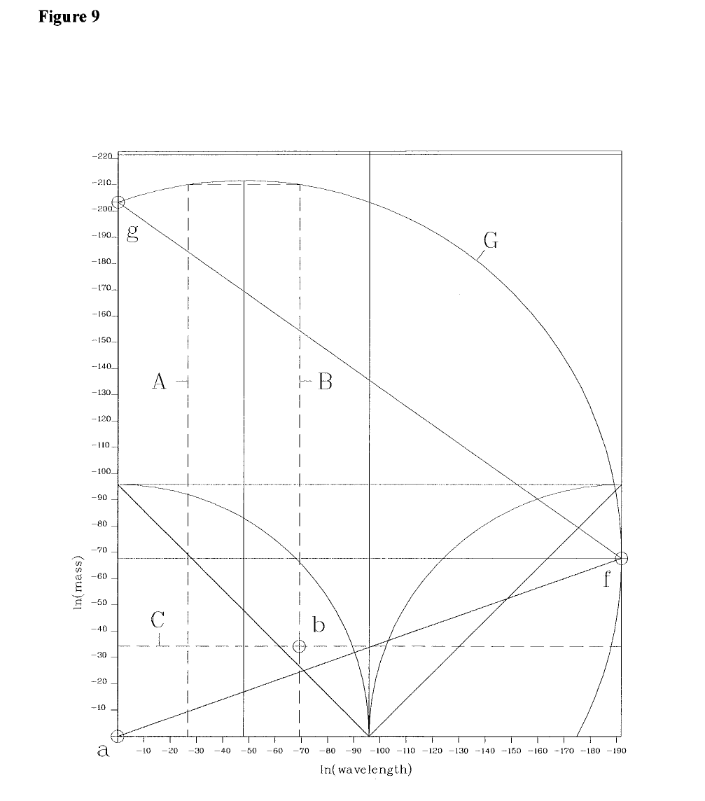

FIG. 10. Tetrahedron diagram showing Planck scale tangent to tetrahedron.

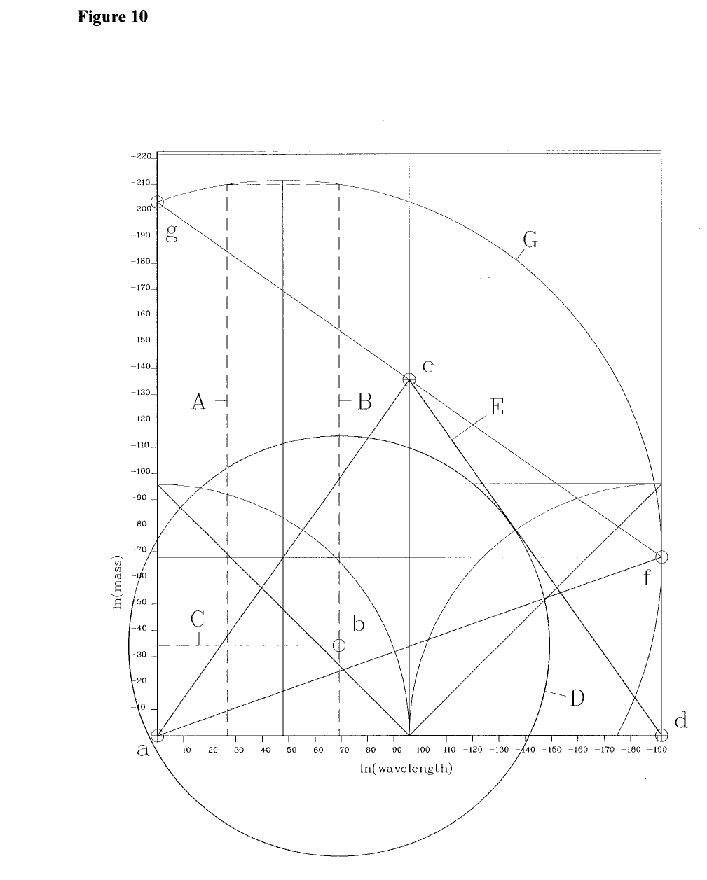

FIG. 11. Tetrahedron diagram showing Planck mass and Planck wavelength intersecting tetrahedron.

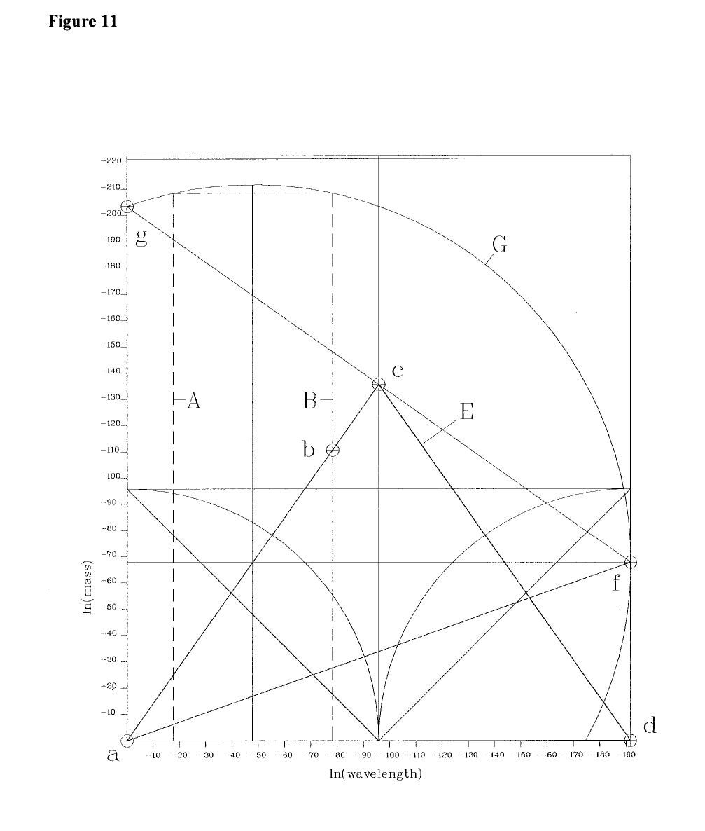

FIG. 12. Tetrahedron diagram showing mirror tetrahedrons across centerline, the boundary between space and hyperspace.

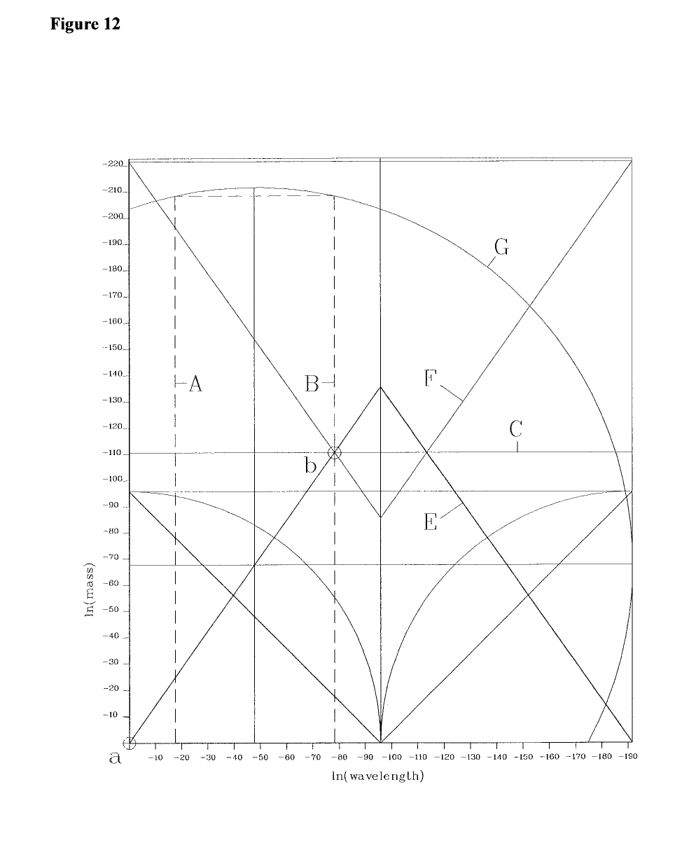

FIG. 13. Tetrahedron diagram showing distance between the base constant and the centerline used to calculate the dimensions of the coaxial cable.

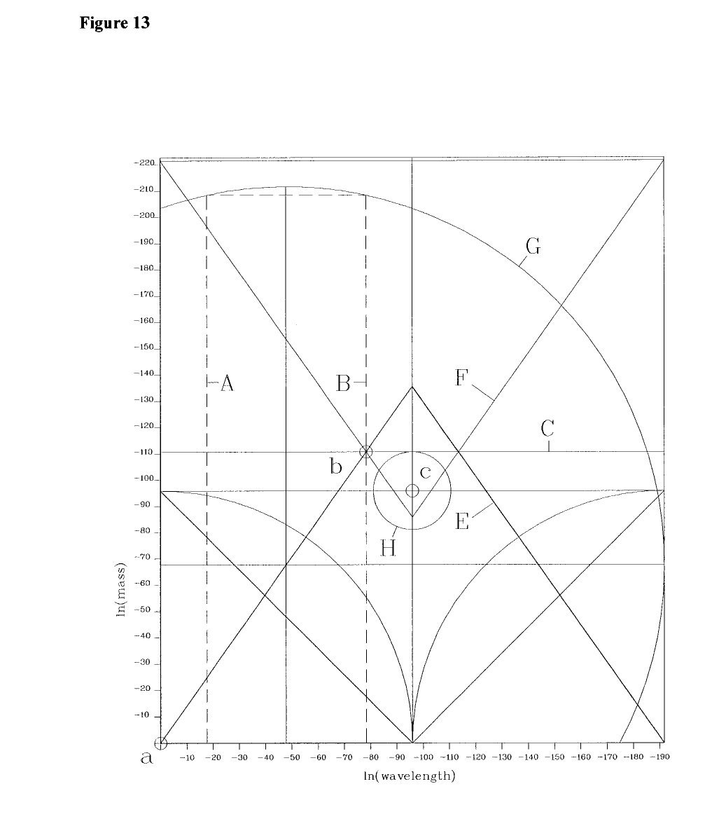

FIG. 14. End view of coaxial cable showing radii a and b used in the subspace geometry constraints in order to couple to hyperspace.

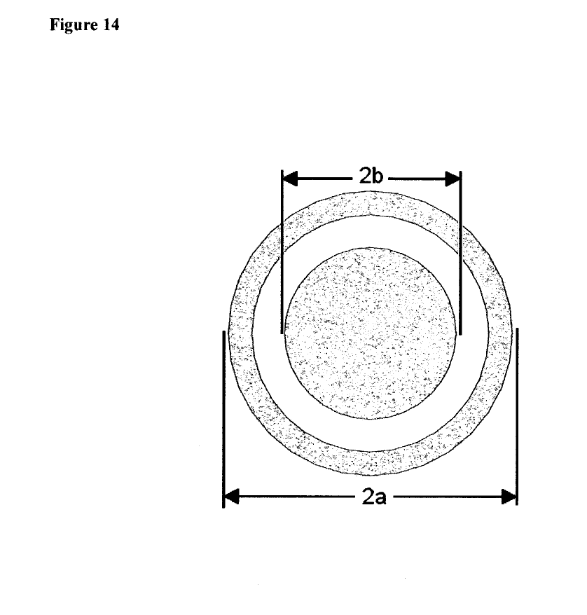

FIG. 15. Perspective view of braided gold wire coaxial cable.

### DETAILED DESCRIPTION OF THE INVENTION

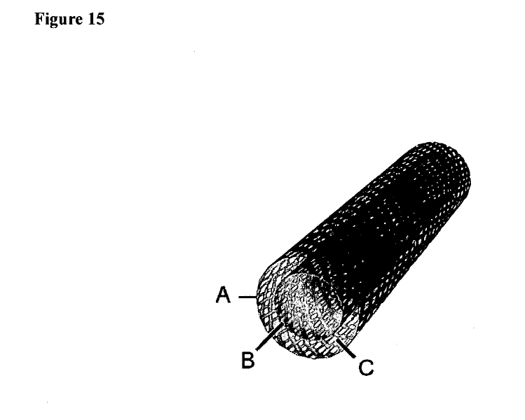

1. Referring to FIG. 15, the coaxial cable has a braided gold wire outer conductor (A) and a braided gold wire inner conductor (B) separated by a dielectric (C). The open braiding promotes the conduction of the electromagnetic wave while allowing the hyperspace mist to seep out of the braid and permeate the surrounding material in which it is embedded.

2. The radius of the outer conductor a and the radius of the inner conductor b have the following values in order to couple the cable to the tetrahedral geometry of subspace.

a=8.342461828·microns

b=7.559058141·microns

3. Even though the wire size is very small, the cable can be made in limited lengths using the new nanotechnology and silicon micromotors.

I claim:

1. A coaxial cable which has:
a) a braided gold wire outer conductor of radius 8.34 microns;
b) a braided gold wire inner conductor of radius 7.56 microns;
c) a thin dielectric separator between the two conductors; and
d) an open weave to allow the hyperspace mist to seep out of the cable and permeate the surrounding material in which the cable is embedded;

2. A specific relationship between the physical dimensions of the coaxial cable, given in items (1a) and (1b), to the following tetrahedral subspace couplings:
a) the ratio of the area-to-volume ratio of the tetrahedron to the area-to-volume ratio of its circumscribing sphere, equal to 3:1, with a coupling to the natural logarithm of the ratio of the radii of the conductors;
b) the ratio of the area of the three-square of the planar tetrahedron to the area of the one-square, equal to 3:1, with a coupling to the Planck mass and the linear inductance of the cable;
b) the distance between the base constant and \sqrt{4/3} times the base constant, equal to −14.83817383 in natural logarithms, with a coupling to the outer radius of the conductor, the ten dimensions of space, and the co-dimensions of hyperspace; and
c) the wave function of the coaxial guide given in terms of item (2c), the natural logarithm of the ratio of the radius of the outer conductor to the radius of the inner conductor, and the curvature 2π.
